(19) United States
(12) Patent Application Publication
(10) Pub. No.: US 2026/0171962 A1
(43) Pub. Date: Jun. 18, 2026

(54) POWER-WATER COGENERATION SYSTEM WITH INTEGRATED THERMAL MANAGEMENT AND WATER GENERATION

(71) Applicant: City University of Hong Kong, Hong Kong (HK)

(72) Inventors: Jian LU, Hong Kong (HK); Zhengyi MAO, Hong Kong (HK)

(21) Appl. No.: 18/986,685

(22) Filed: Dec. 18, 2024

(51) Int. Cl. H02S 40/42; E03B 3/28; F25B 19/00

(52) U.S. Cl. CPC H02S 40/425; E03B 3/28; F25B 19/00

(57) ABSTRACT

The present invention relates to an ultra-cooling patch (UCP) designed for photovoltaic (PV) panels, offering enhanced power generation efficiency through advanced thermal management and simultaneous freshwater production. The UCP features a flexible and adhesive structure including an atmospheric water harvester (AWH), a thermal regulating layer, and an adhesive layer. The UCP reduces PV panel temperatures by approximately 30° C., boosting power density by over 28%. Its lightweight, scalable, and easy-to-install design ensures compatibility with various PV systems, addressing global energy and water challenges sustainably.

### FIELD OF THE INVENTION

The present invention generally relates to at least the fields of solar energy technology, photovoltaic systems, thermal management, and passive cooling technologies.

### BACKGROUND OF THE INVENTION

The use of solar energy for electricity generation offers a sustainable solution to address global energy and water shortages. Among solar technologies, photovoltaic (PV) systems are the most widely adopted for converting solar energy into electricity. However, PV cells typically convert only a small portion of the solar spectrum (e.g., 300-1100 nm for silicon cells), resulting in over 70% of the incident energy being wasted as heat. This excess heat increases the temperature of the PV panels, reducing both their power output and lifespan. Studies show that each degree rise in temperature results in a 0.4-0.5% reduction in efficiency.

Recent efforts have focused on passive thermal management technologies for PV cooling, offering benefits such as zero global warming potential, low maintenance costs, and simplicity. However, existing designs often fail to optimize energy interaction between the cooling components and the PV system or evaporation layers, limiting cooling effectiveness. Additionally, their complexity in installation and disassembly hinders large-scale deployment.

Therefore, there is a need for a simple, efficient, and scalable passive cooling technology that can significantly enhance the performance and longevity of PV systems.

### SUMMARY OF THE INVENTION

In light of the aforementioned challenges, the present invention provides power-water cogeneration system with integrated thermal management and water generation, which includes a PV panel for converting sunlight into electrical power, an ultra-cooling patch (UCP) attached to the PV panel, and a desalination unit for converting saline water into freshwater using the thermal energy captured by the UCP. The atmospheric water harvester (AWH) layer captures moisture from air during nighttime, facilitating a radiative cooling effect, while the PV panel enhances moisture absorption efficiency, during daylight hours, excess heat from the PV panel is used to evaporate water within the UCP, and the latent heat of evaporation contributes to cooling the PV panel.

The UCP includes an AWH layer with aligned channels, a thermal regulating layer configured to dissipate heat through latent heat evaporation and enhanced thermal conduction, and an adhesive layer enabling secure and reversible attachment of the UCP to the PV panel.

In one embodiment, the AWH layer includes a hydrogel material crosslinked with hygroscopic materials for capturing and storing moisture.

In one embodiment, the hydrogel material includes polyurethane, melamine, cellulose, alginate, polyvinyl alcohol, polyacrylamide, and the hygroscopic materials include LiCl, CaCl₂, MgCl₂, ZnCl₂, Mofs, or a combination thereof.

In one embodiment, the AWH layer contains pores interconnected with low tortuosity channels for rapid mass and heat transfer.

In one embodiment, the thermal regulating layer is formed from materials with high thermal conductivity selected from graphite, aluminum, or copper.

In one embodiment, the adhesive layer includes silicone-based materials, acrylic acid, Sec-Butyl acetate, or a combination thereof.

In one embodiment, the silicone-based materials include polydimethylsiloxane, a silicone elastomer, and a silicone adhesive, or a combination thereof.

In one embodiment, the PV panel includes a rigid PV panel and a flexible PV panel.

In one embodiment, the UCP has a thickness of 1 mm to 15 mm.

In one embodiment, the UCP reduces the operating temperature of the PV panel by at least 24° C. under typical solar exposure, thereby increasing the power generation efficiency of the PV panel by at least 20%.

In one embodiment, the thermal regulating layer maintains a cooling power density of at least 600 W/m² under high solar intensity conditions.

In one embodiment, the adhesive layer enables the UCP to undergo at least 50 cycles of attachment and detachment without loss of adhesion.

In one embodiment, the UCP achieves a super high cooling power of almost 700 W m⁻² and enabling recycle of over 70% waste heat from solar for freshwater production.

In another embodiment, the UCP is further configured into a fin-like structure, called folded UCP (FUCP), with an increased surface area of at least 30% to enhance the cooling rate. This modification contributes to a notable temperature decrease of around 30° C. for the PV panel, leading to a significant boost in maximum power density, with an increase of more than 28%.

In another aspect, the present invention provides a method for improving photovoltaic panel performance and generating freshwater, including attaching said UCP to a PV panel; harvesting the moisture from ambient air during nighttime via the AWH layer; and dissipating heat during daylight hours via the thermal regulating layer to reduce the temperature of the PV panel; and condensing vapor produced by the UCP to generate freshwater. The method enhances power generation efficiency by maintaining the PV panel at an optimal operating temperature while simultaneously generating freshwater.

In one embodiment, the hydrogel material is crosslinked using a 30 wt. % calcium chloride solution.

In another embodiment, the method further including reshaping the UCP into a folded configuration to enhance heat transfer efficiency.

In one embodiment, the moisture captured by the AWH is stored in a condensation chamber for subsequent use in irrigation or drinking.

In one embodiment, the UCP maintains its cooling performance over a three-month period under fluctuating environmental conditions.

This reduction in temperature optimizes the efficiency of solar energy conversion, addressing the issue of thermal degradation commonly faced by PV systems, and unlocking the full power generation potential of existing PV installations.

In addition to its cooling capabilities, the UCP offers a range of advantages due to its flexibility and adhesive properties. The patch is easy to deploy, ensuring a simple and cost-effective installation process that does not require specialized tools or complex procedures. Its flexible design allows for compatibility with both rigid and flexible PV panels, making it suitable for a wide variety of PV systems. The adhesive backing of the UCP ensures long-term durability, withstanding outdoor environmental conditions such as UV exposure, temperature fluctuations, and moisture.

This dual-purpose system offers several significant advantages:
1. The system enables the production of both electricity and freshwater in parallel, addressing two critical needs in many regions, particularly in arid areas or places affected by water scarcity.
2. By keeping the PV panel cooler through the UCP, the system enhances the overall efficiency of electricity generation, which is a key factor in maximizing the utility of solar energy systems.
3. This approach reduces the reliance on separate energy and water production systems, optimizing both resources and operational costs.
4. The system is scalable, making it applicable for use in a wide range of settings, from small-scale residential applications to larger commercial and industrial installations.

### BRIEF DESCRIPTION OF THE DRAWINGS

Embodiments of the invention are described in more details hereinafter with reference to the drawings, in which:

FIG. 1 shows a schematic diagram of UCP according to the present invention;

FIG. 2 shows a schematic diagram of UCP for cooling flexible PV;

FIG. 3A shows a schematic diagram of the reshaped UCP designed to passively intensify heat transfer from the PV panel. FIG. 3B shows the PV/FUCP system with a large TRL-AWH interface and a large AWH-air interface;

FIG. 4 shows comparison on volume change of prepared sodium alginate (SA) hydrogel and polyacrylamide (PAM) hydrogel. The dot areas represent 10*10 mm regions;

FIG. 5 shows the preparation process of the SA hydrogel skeleton;

FIG. 6 shows scanning electron microscopy (SEM) images of the aligned channels of the hydrogel sponge;

FIG. 7 shows moisture sorption-desorption isotherms of hygroscopic salts under 25° C. at 60% RH;

FIG. 8 shows water sorption performance of the AWH with aligned channels and random channels. Insets shows the mechanism of the fast sorption of aligned channels;

FIG. 9 shows lap-shear adhesion strength of adhesive layer on different substrates;

FIG. 10 shows optical images of the patch adhesive on different materials;

FIG. 11 shows lap-shear adhesion tests of UCP under repeated adhesion and detachment cycles on silicon wafer;

FIG. 12 shows the effect of the UCP thickness on the cooling performance;

FIG. 13 shows a schematic of moisture capture from air during nighttime, and power-water cogeneration via solar irradiation during daytime;

FIG. 14 shows power-voltage curves of PV and PV-UCP under 1 sun illumination at ambient temperature of around 35° C. and 40° C., respectively;

FIG. 15 shows power-voltage curves of pristine flexible PV and flexible PV-UCP;

FIG. 16 shows schematics of FUCP for enhanced cooling efficiency;

FIG. 17 shows temperature changes of the pristine PV panel, PV-UCP and PV-FUCP;

FIG. 18 shows calculated energy flow of the pristine PV, PV-UCP and PV-FUCP;

FIG. 19 shows a comparison of the charging capacity for a smartwatch using the pristine PV panel versus the PV-FUCP under 1 sun illumination for 10 minutes;

FIG. 20 shows a photo of the prepared PV-FUCP unit with size of 1270 mm×760 mm;

FIG. 21 shows a schematic diagram of a water condensation chamber; and

FIG. 22 shows a schematic of fast mass/heat transport in AWH.

### DETAILED DESCRIPTION

Solar PVs are widely used for generating electricity from solar energy. However, the heat generated by the photothermal effect in PV panels can negatively impact both their efficiency in energy production and their overall lifespan.

Accordingly, the present invention introduces an adhesive and flexible ultra-cooling patch (UCP) that provides efficient thermal management for PV panels, while simultaneously offering a means to extract moisture from the air and produce freshwater. It can boost the power generation performance of existing 1500 GW PV installations while also facilitating the production of freshwater.

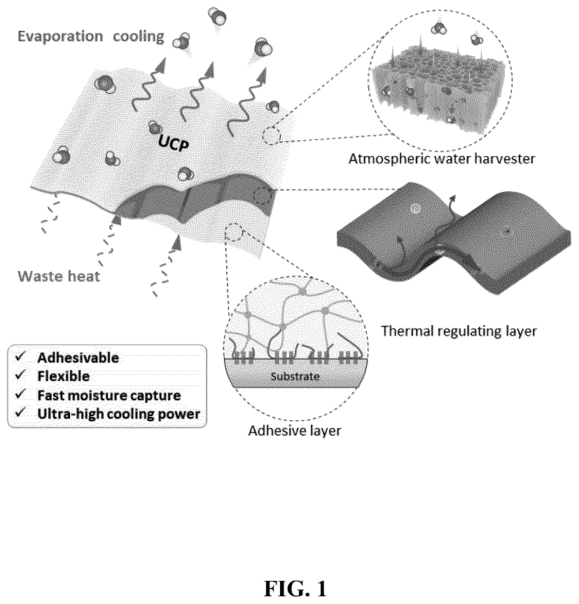

As shown in FIG. 1, the UCP includes three distinct layers: an AWH, a thermal regulating layer, and an adhesive layer.

The AWH is constructed from a hydrogel material featuring a network of aligned channels and interconnected pores. This structure enhances the material's ability to rapidly absorb moisture from the air. When infused with hygroscopic materials, the hydrogel facilitates efficient moisture uptake through the low-resistance channels, allowing the system to harvest water from ambient humidity.

In one embodiment, the hydrogel material may include polyurethane, melamine, cellulose, alginate, polyvinyl alcohol, polyacrylamide. The hygroscopic materials may include LiCl, CaCl₂, MgCl₂, ZnCl₂, Mofs, or a combination thereof.

The thermal regulating layer is designed to manage the heat transfer dynamics of the UCP. It provides fast heat dissipation pathways, which help maintain optimal operating temperatures for underlying systems such as photovoltaic panels, preventing overheating and improving efficiency.

In one embodiment, the thermal regulating layer is formed from materials with high thermal conductivity. Example of the high thermal conductivity material may include graphite, aluminum, or copper.

The adhesive layer enables the UCP to be securely attached to various substrates, ensuring a tight and reversible bond. This layer allows the UCP to be installed on different surfaces without permanently altering or damaging the substrate, making the system versatile and easy to implement.

In one embodiment, the adhesive layer may include silicone-based materials, acrylic acid, Sec-Butyl acetate, or a combination thereof.

A key advantage of the UCP is its dual functionality, addressing both the energy and water crises. The UCP is engineered to function effectively in two primary modes: (1) moisture extraction at night and (2) heat dissipation during the day.

For (1), during the nighttime, the UCP is capable of rapidly absorbing and extracting moisture from the air. This is achieved through a combination of materials and structures designed to maximize surface area and moisture retention. The UCP's design takes advantage of lower nighttime temperatures and higher humidity, facilitating the condensation of water vapor onto its surface, which can then be collected for use as freshwater.

For (2), during daylight hours, when the PV panel is exposed to direct sunlight, the UCP functions as a passive cooling system. By dissipating waste heat through evaporation, the UCP prevents the PV panel from overheating, thereby maintaining its efficiency and extending its operational lifespan. The system utilizes the heat absorbed from the PV panel to drive the evaporation process, ensuring continuous energy exchange between the UCP and the PV panel, even under high-intensity solar conditions.

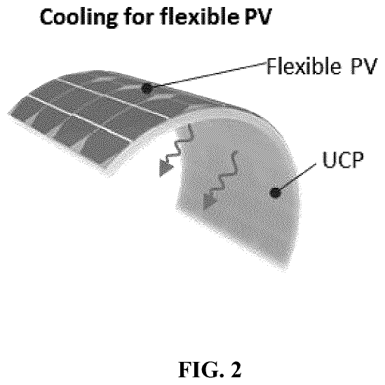

The UCP's unique combination of flexibility and adhesion allows for easy installation on a wide variety of PV panels. Examples of the PV panels may include a rigid PV panel and a flexible PV panel. The adhesive backing ensures a secure attachment without compromising the integrity or performance of the PV module. For flexible PV panels (FIG. 2), the UCP can be seamlessly integrated, conforming to the shape of the panel without causing mechanical stress or damage.

The integration of the UCP with a PV panel results in a remarkable temperature reduction of approximately 30° C., which is achieved through passive cooling during periods of high solar intensity. This temperature reduction is critical because it prevents the PV panel from operating at excessively high temperatures, which can reduce its efficiency and potentially shorten its lifespan. Furthermore, the UCP's cooling capabilities lead to a significant increase in the maximum power density of the PV panel. Specifically, the PV panel's power density can be increased by more than 28% due to the reduced operating temperature, allowing the PV panel to generate more electrical power over its operational lifetime.

In terms of thermal management, the UCP is capable of providing a passive cooling power of up to 700 W m⁻², which is highly efficient and can be maintained continuously under typical outdoor conditions. This ensures that the PV panel remains at an optimal temperature throughout the day, even under intense sunlight, thereby improving overall system performance.

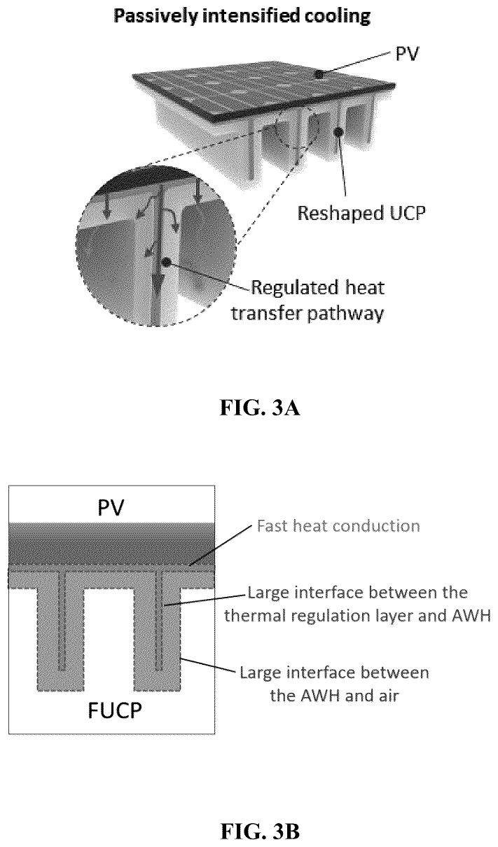

Moreover, a key feature of the UCP is its fin-like structure, which boosts the interface between the UCP and the PV panel, increasing the surface area for heat exchange. The increased surface area improves passive cooling by allowing for more efficient thermal dissipation from the PV panel to the surrounding environment. When reshaped into a FUCP, heat transfer pathways are optimized, further enhancing the heat exchange between the PV panel and UCP (FIGS. 3A-3B). Consequently, the system achieves ultra-high cooling power density and improved performance in electricity and water generation.

To quantitatively evaluate the impact of the UCP and FUCP, the energy balance for the pristine PV panel, PV-UCP, and PV-FUCP systems is calculated. The analysis considers various energy components, including convection, radiation, evaporation, and power generation, with solar irradiation serving as the energy input. The input solar power (Pᵢₙₚᵤₜ) can be calculated by equation (1):

$${P}_{input} = α {C}_{opt} {q}_{i} {A}_{pro} , \qquad ( 1 )$$

where α is the optical absorption coefficient, Cₒₚₜ represents the optical concentration; and qi is the normal direct solar irradiation (1 kW m⁻² for 1 sun at AM 1.5), Aₚᵣₒ is the project area of the absorber

The radiation loss of the pristine PV (P_{rad,PV}), PV-UCP (P_{rad,PV-UCP}), and PV-FUCP (P_{rad,PV-FUCP}) can be calculated by equation (2), (3) and (4), respectively:

$${P}_{rad , PV} = {A}_{pro} {ε}_{1} σ ( {T}_{1}^{4} - {T}_{0}^{4} ) + {A}_{sid , PV} {ε}_{2} σ ( {T}_{2}^{4} - {T}_{0}^{4} ) + {A}_{b ack , PV} {ε}_{3} σ ( {T}_{3}^{4} - {T}_{0}^{4} ) , \qquad ( 2 )$$

$${P}_{rad , PV - UCP} = {A}_{pro} {ε}_{1} σ ( {T}_{4}^{4} - {T}_{0}^{4} ) + {A}_{sid , PV - UCP} {ε}_{4} σ ( {T}_{5}^{4} - {T}_{0}^{4} ) + {A}_{b ack , PV - UCP} {ε}_{4} σ ( {T}_{6}^{4} - {T}_{0}^{4} ) , \qquad ( 3 )$$

$${P}_{rad , PV - FUCP} = {A}_{pro} {ε}_{1} σ ( {T}_{7}^{4} - {T}_{0}^{4} ) + {A}_{sid , PV - FUCP} {ε}_{4} σ ( {T}_{8}^{4} - {T}_{0}^{4} ) + {A}_{b ack , PV - FUCP} {ε}_{4} σ ( {T}_{9}^{4} - {T}_{0}^{4} ) , \qquad ( 4 )$$

where σ is the Stefan-Boltzmann constant, A_{sid,PV}, A_{sid,PV-UCP}, A_{sid,PV-FUCP}, A_{back,PV}, A_{back,PV-UCP}, A_{back,PV-FUCP} are the area of the PV, PV-UCP and PV-FUCP side and back surface, respectively; ε₁, ε₂, ε₃, ε₄, ε₅, are the optical emission of the top, side and back surface of PV. ε₄, are optical emission of the side surface of the UCP. T₀, is the room temperature; T₁, T₂, T₃, T₄, T₅, T₆, T₇, T₈, T₉, are the temperature of top, side and back temperature of PV, PV-UCP and PV-FUCP, respectively.

The convention loss of the pristine PV (P_{conv,PV}), PV-UCP (P_{conv,PV-UCP}), and PV-FUCP (P_{conv,PV-FUCP}) can be calculated by equation (5), (6) and (7), respectively:

$${P}_{conv , PV} = {A}_{pro} h ( {T}_{1} - {T}_{0} ) + {A}_{sid , PV} h ( {T}_{2} - {T}_{0} ) + {A}_{b ack , PV} h ( {T}_{3} - {T}_{0} ) , \qquad ( 5 )$$

$${P}_{conv , PV - UCP} = {A}_{pro} h ( {T}_{4} - {T}_{0} ) + {A}_{sid , PV - UCP} h ( {T}_{5} - {T}_{0} ) + {A}_{b ack , PV - UCP} h ( {T}_{6} - {T}_{0} ) , \qquad ( 6 )$$

$${P}_{conv , PV - FUCP} = {A}_{pro} h ( {T}_{7} - {T}_{0} ) + {A}_{sid , PV - EUCP} h ( {T}_{8} - {T}_{0} ) + {A}_{back , PV - FUCP} h ( {T}_{9} - {T}_{0} ) , \qquad ( 7 )$$

where h is the convection heat transfer coefficient.

The latent heat induced by the evaporation can be calculated by equation (8):

$${P}_{latent} = {M}_{eva} {H}_{vap} {A}_{pro} , \qquad ( 8 )$$

where Mₑᵥₐ is the evaporation rate, Hᵥₐₚ is the equivalent evaporation enthalpy.

The PV-FUCP achieves a cooling power of up to 692 W/m², significantly outperforming radiative cooling (typically under 150 W/m²), evaporation cooling, and other passive heat management techniques for PV panels.

This remarkable cooling efficiency is attributed to three main factors: i) efficient mass transfer within the aligned channels of the AWH, where the low tortuosity reduces diffusion resistance, enabling faster sorption and evaporation rates; ii) the high thermal conductivity of the thermal regulation layer, along with the large interface between this layer and the AWH, allows for rapid heat transfer from the PV panel to the UCP; and iii) the expansive interface between the AWH and air facilitates the release of water vapor, promoting latent heat evaporation and further enhancing the cooling effect on the PV panel.

Furthermore, augmenting the thickness and thermal conductivity of the thermal regulating layer can enhance the heat transfer capacity of the FUCP, which promotes heat dissipation and results in a lower temperature of the photovoltaic panel.

In another aspect, the present invention provides a method for generating freshwater, including condensing vapor produced by said ultra-cooling patch. By capturing and condensing moisture from the air during the night, the system contributes to freshwater production, which is especially valuable in areas facing water scarcity. In combination with PV energy generation, the UCP offers a sustainable, dual-purpose solution that provides both renewable energy and clean water, making it a highly effective tool for addressing global energy and water challenges.

### EXAMPLE

### Example 1

### Synthesis and Characterization of the UCP

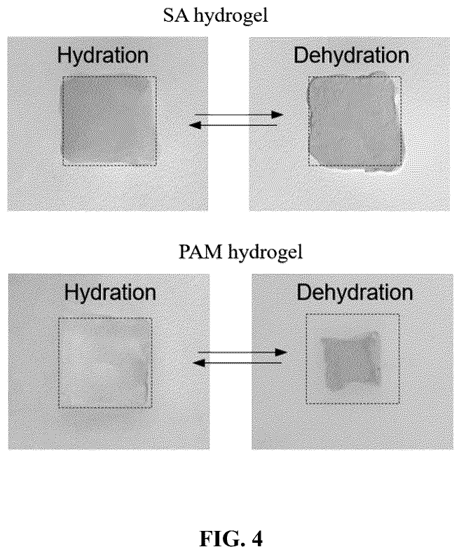

First, FIG. 4 compares the volume change of two hydrogels: SA hydrogel and PAM hydrogel, showing that the SA hydrogel undergoes negligible shrinkage during the hydration-dehydration cycle, while the PAM hydrogel shrinks by nearly half. This superior stability of SA hydrogel ensures better performance for the UCP, as it maintains its shape and adhesion to the PV panel during use.

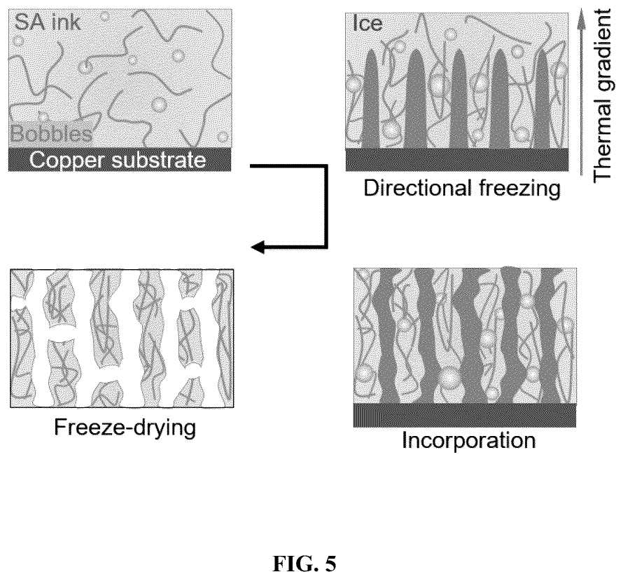

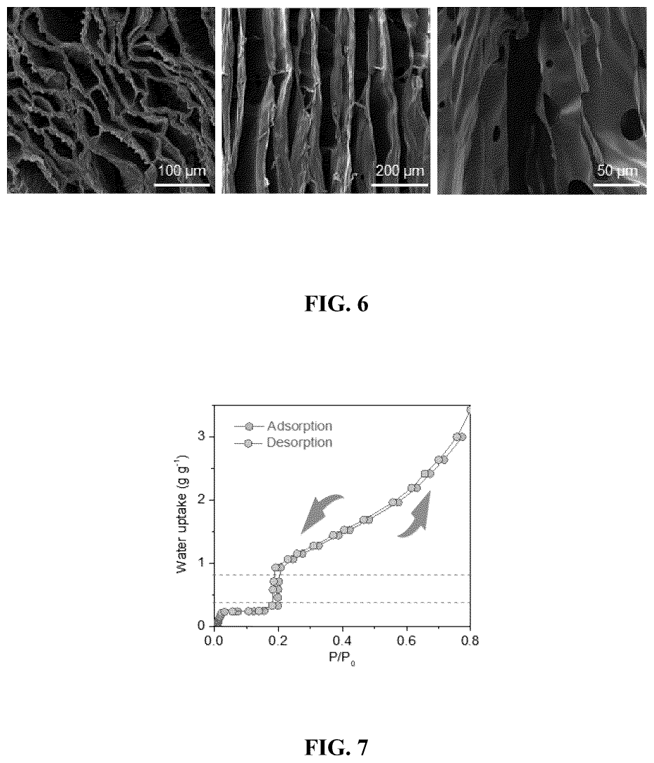

To fabricate the AWH, hygroscopic salts are selected for their excellent moisture absorption capabilities, and SA hydrogel serves as the matrix to host these salts. 3 wt. % sodium alginate is first dissolved in DI water and stirred for 24 hrs. Then, the solution is pured into a customized copper mould for directional freezing. Finally, the evaporator was lyophilized at −55° C. at a vacuum pressure of 0.01 mbar for 48 hrs. The combination of SA hydrogel with hygroscopic salts enables efficient moisture harvesting while maintaining the dimensional stability required for the UCP to function effectively in energy-water cogeneration applications. In addition, the porous structure of the hydrogel allows for the storage of captured water and prevents the aggregation of salt particles during the sorption/desorption cycles. The vertically aligned porous structure of the SA hydrogel skeleton is obtained by directional freezing casting method, as shown in FIG. 5. The prepared SA ink is stirred for over 24 hours and rapidly frozen at −80° C. on a copper substrate to facilitate directional ice crystallization. Once the ice crystals are removed, the aligned channels and hierarchical pores are formed (FIG. 6). The bubbles within the ink interconnected the channels to facilitate rapid mass transfer. The SA skeleton is then crosslinked by immersing it in a 30 wt. % CaCl₂) solution. Referring to FIG. 7, the superior water uptake performance of CaCl₂ (>3 g g⁻¹) facilitates fast moisture capture from air.

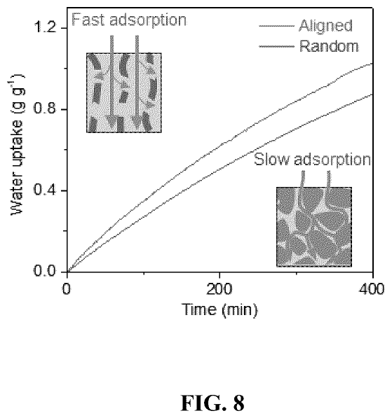

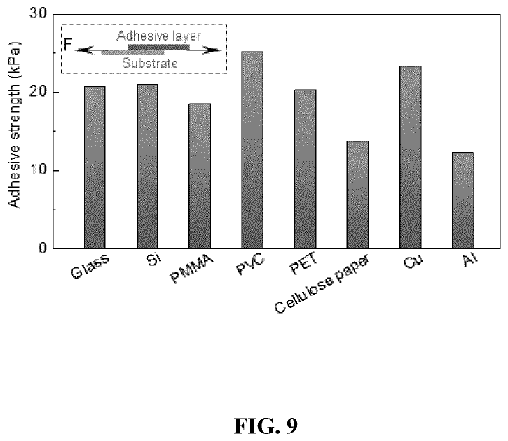

Referring to FIG. 8, the water sorption performance of the AWH with different pore structures is illustrated. The AWH featuring an aligned channel pore structure demonstrates faster sorption kinetics, resulting in quicker water uptake compared to the random pore structure. This enhanced performance is due to the low tortuosity of the aligned channels, which reduces the mass transfer resistance for water vapor transport.

The thermal regulation layer is typically sourced from the market. Different metal films, including aluminum and copper, can be employed, with thicknesses between 0.1 mm and 1 mm.

To fabricate the adhesive layer, silicone-based materials are used, with Sylgard 184 and SE 1700 being mixed in a 1:1 mass ratio to achieve a stable viscosity and reliable adhesion. This adhesive mixture is applied to the AWH, followed by the placement of a 150 μm copper sheet, with both sides coated with the adhesive ink. The sample is then cured at 55° C. for 8 hours.

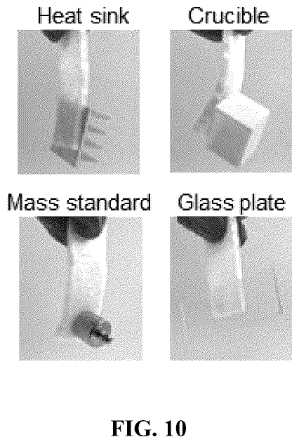

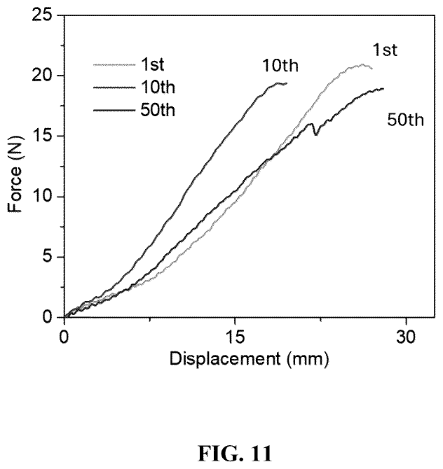

The adhesion strength of the UCP is evaluated using lap-shear tests on various substrates (FIG. 9). For instance, the UCP can adhere securely to polymers, metals, ceramics, and glass (FIG. 10). Additionally, after undergoing 50 cycles of adhesion and detachment, the UCP remains strongly attached to the silicon wafer, highlighting its excellent reversibility (FIG. 11).

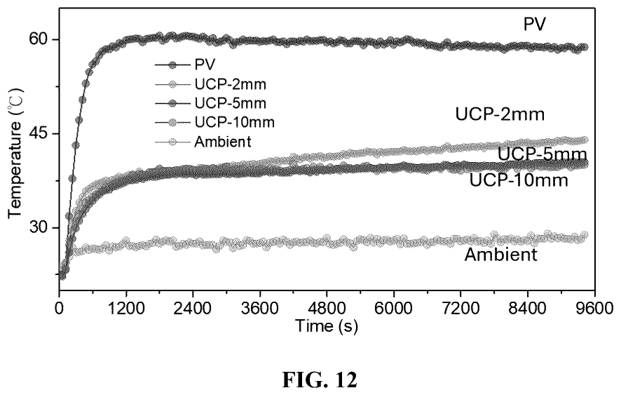

FIG. 12 shows the impact of UCP thickness on cooling performance. The unmodified PV panel maintains significantly higher temperatures compared to the PV-UCPs, highlighting the effective passive cooling provided by the UCP. During the first hour of exposure to 1 sun, all three PV-UCPs demonstrate similar cooling effectiveness. However, as the exposure time increases, the temperature of the PV-UCP with a 2 mm thickness rises slightly, while the temperatures of the 5 mm and 10 mm thick PV-UCPs remain stable. This behavior can be attributed to the increased latent cooling capacity of the thicker UCPs. As evaporation continues, the 2 mm thick PV-UCP experiences a rapid reduction in water content, leading to decreased cooling efficiency. In contrast, the 5 mm and 10 mm thick UCPs retain sufficient water content, maintaining consistent and stable cooling performance.

### Example 2

### Fabrication of a PV-UCP Power-Water Cogeneration System

To fabricate a PV-UCP power-water cogeneration system, the process begins with selecting a suitable PV panel, typically commercial-grade monocrystalline or polycrystalline silicon, based on energy needs and environmental factors. The UCP is made according to Example 1, which consists of an atmospheric water harvester made from hydrogel infused with hygroscopic materials (e.g., calcium chloride or silica gel) to absorb moisture, a thermal regulating layer using materials with high thermal conductivity (such as graphite or aluminum) to dissipate heat, and an adhesive layer that allows secure, reversible attachment of the UCP to the PV panel. Additionally, a reverse osmosis (RO) desalination unit is integrated to convert seawater or brackish water into potable freshwater, utilizing thermal energy captured by the UCP for the desalination process.

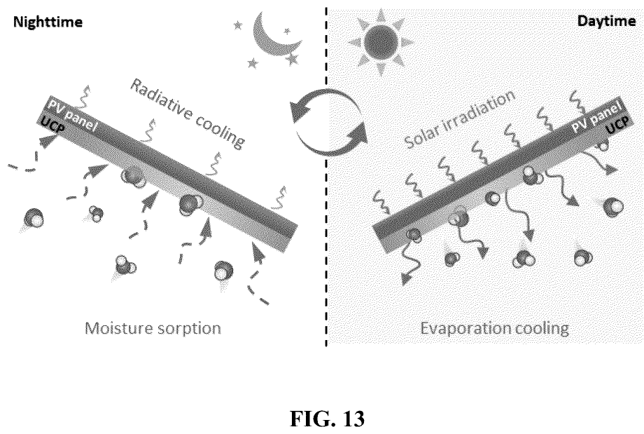

The mechanism of PV-UCP power-water cogeneration system is shown in FIG. 13. At night, the UCP absorbs moisture from the air, with the aligned channels in the UCP and the radiative cooling effect of the PV panel improving the moisture absorption efficiency. During the day, the PV panel generates both electricity and heat when exposed to sunlight. The excess heat is used to evaporate water within the UCP, and the latent heat from evaporation helps cool the PV panel. This dual process results in the simultaneous production of freshwater and an increase in electricity generation.

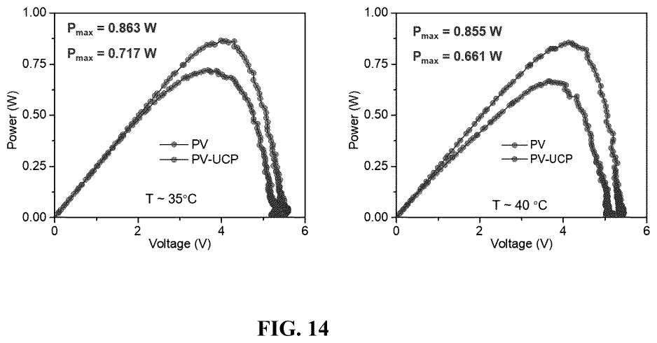

FIG. 14 presents the power-voltage curves of the PV and PV-UCP under 1 sun illumination at ambient temperatures of approximately 35° C. and 40° C. As the ambient temperature increased from 35° C. to 40° C., the maximum power density of the unmodified PV panel drops significantly from 0.717 W to 0.661 W. In contrast, the maximum power density of the PV-UCP decreases by only 0.008 W, highlighting the effective cooling performance of the UCP. These results demonstrate that the passive cooling strategies employed by the UCP remain effective even under high-temperature operating conditions.

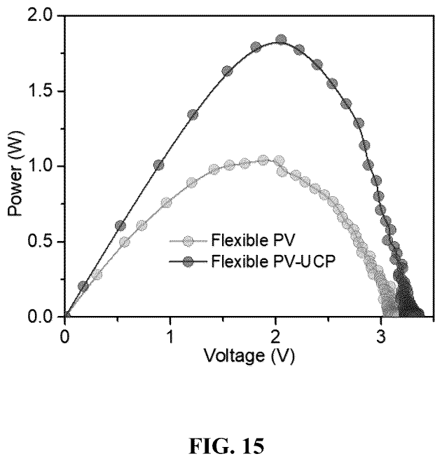

Furthermore, when a flexible PV panel (as shown in FIG. 2) is used in place of a standard one, FIG. 15 compares the power generation performance of the flexible PV panel and the flexible PV-UCP. The results show that the maximum power density of the flexible PV-UCP is increased by approximately 72% compared to the flexible PV alone, which can be attributed to the cooling effect provided by the UCP.

### Example 3

Enhanced Cooling Performance of PV Panels with FUCP for Improved Power Generation

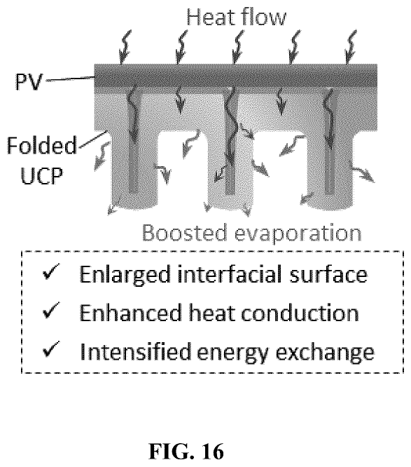

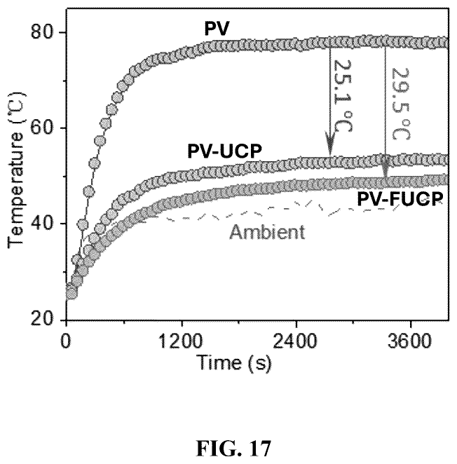

FIG. 16 demonstrates an improvement in cooling performance by reshaping the UCP, leveraging its flexibility and adhesive properties. By folding the UCP to FUCP, the contact area between the thermal regulation layer and the AWH, as well as between the AWH and air, is greatly increased. This increase in surface area facilitates greater heat transfer from the PV panel to the FUCP, thereby improving the overall heat exchange and enhancing cooling efficiency. As a result, the FUCP reduces the temperature of the PV panel by 29.5° C., which is nearly 5° C. lower than the cooling performance achieved by the UCP (FIG. 17). Benefiting from the ultra-high cooling efficiency of the FUCP, the electrical generation performance of the PV is markedly boosted.

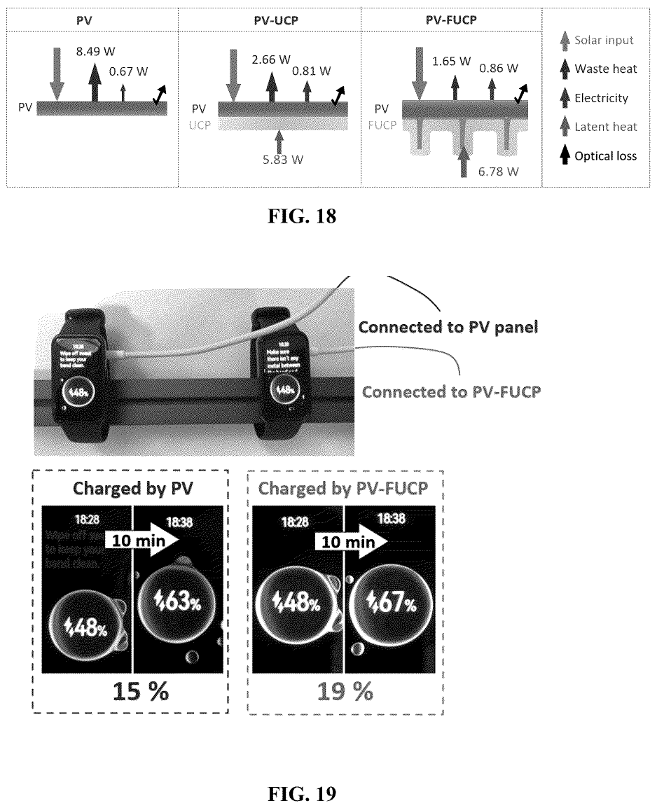

FIG. 18 illustrates the calculated energy flow for the pristine PV, PV-UCP, and PV-FUCP. For the unmodified PV panel, over 80% of the incident solar energy (8.49 W) is converted into heat, which is subsequently dissipated into the surrounding environment. In contrast, the PV-UCP effectively removes a substantial amount of heat (5.83 W) through water evaporation, accounting for 69% of the total waste heat. After reshaping the UCP into the FUCP, the passive cooling performance is significantly enhanced, increasing the latent heat removal by 0.95 W, resulting in an ultra-high cooling power of 692 W/m². This cooling performance is notably higher than that of advanced radiative cooling methods (40-140 W/m²), atmospheric water sorption-evaporation cooling (295 W/m²), and other emerging evaporation-based cooling solutions (180-400 W/m²).

Referring to FIG. 19, to illustrate the improved power generation capability of the FUCP design, two smartwatches (Band 8, HUAWEI) are charged individually using the PV-FUCP and PV-UCP under 1 sun exposure. After 10 minutes of charging, the smartwatch connected to the PV-FUCP charges 19% of its battery, while the PV-UCP results in only a 15% increase in battery capacity. This comparison clearly illustrates the significant improvement in power generation efficiency achieved by the passive ultra-cooling strategy, highlighting its practical potential.

### Example 4

### Large-Scale Solar Applications

The UCP is integrated with a 1 m² commercial-grade PV panel, located in an outdoor setting under typical environmental conditions. The UCP is installed directly onto the surface of the PV panel using a specially designed adhesive layer that allows for secure attachment without compromising the performance or integrity of the PV module. This installation is carefully monitored throughout its operational period to evaluate the impact on the PV panel's energy generation efficiency.

Through its innovative cooling design, the UCP effectively lowers the operating temperature of the PV panel by up to 10° C. compared to standard, uncooled PV systems. This reduction prevents overheating, which is a common issue that can lead to reduced efficiency and shorter lifespan of PV panels. By maintaining the UCP within an optimal operating temperature range, the UCP ensures that the PV panel functions at peak efficiency, thereby increasing the overall energy output. Furthermore, the UCP is found to significantly enhance the absorption of the full solar energy spectrum, including both visible and infrared light, resulting in more efficient conversion of solar radiation into electrical power.

Additionally, the system is tested outdoors over a three-month period, under varying conditions such as fluctuating ambient temperatures, solar radiation, and humidity levels. The results consistently show that the UCP maintains stable cooling performance, significantly reducing the thermal load on the PV panel. This sustained cooling effect contributes to an average increase of 18% in energy output compared to an uncooled panel under similar conditions. The UCP's ability to maintain this level of efficiency over extended periods highlights its durability and suitability for real-world applications.

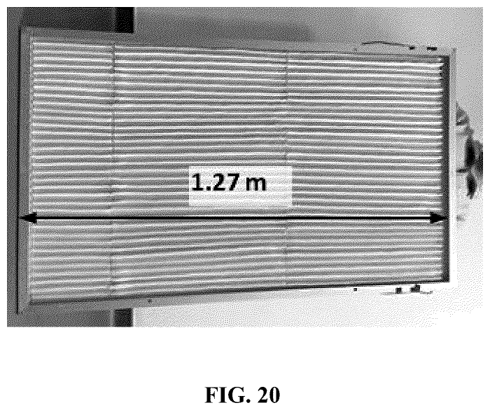

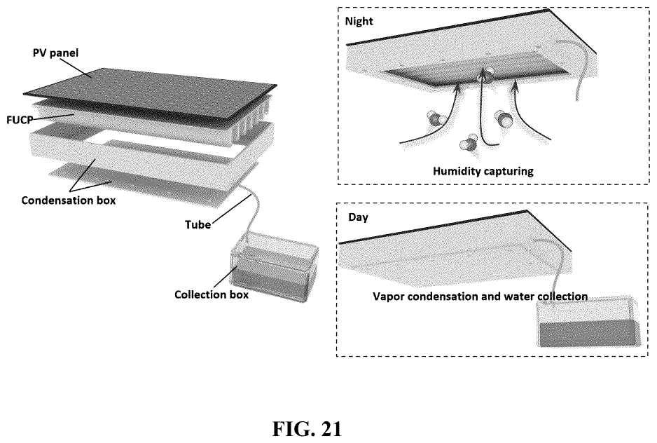

For large-scale applications, the UCP is enhanced and scaled up to form the PV-FUCP system. Constructed using commercially available materials, such as melamine sponge and copper tape, the PV-FUCP is designed to provide efficient cooling across larger PV panels. The UCP, with dimensions of 2000 mm by 1000 mm, is flexible and easily rolled for convenient storage and transport. It is securely attached to the back of a commercial PV panel (1270 mm by 760 mm), forming the PV-FUCP system (FIG. 20). In addition to its cooling function, the system integrates a condensation chamber positioned behind the PV panel to collect over 2.2 kg of water. A tube is connected to the condensation chamber for water collection. The water can be used for domestic purposes, such as irrigation or drinking, or for self-cleaning the PV panel (FIG. 21). During nighttime, the rear panel of the condensation chamber was opened to facilitate humidity capture. In contrast, during daytime, the rear panel was closed to allow vapor condensation and water collection.

This multi-functional system not only enhances energy efficiency by maintaining an optimal operating temperature but also offers a sustainable water management solution, making it ideal for large-scale solar installations in diverse environmental conditions.

### Example 5

### Dual-Function of UCP for Simultaneous Electricity Generation and Freshwater Production

In this example, the UCP is coupled with a PV panel to perform electricity generation and freshwater production at the same time. The PV panel generates electricity through the conversion of sunlight into electrical power. Excess thermal energy from the PV panel, which would otherwise be wasted, is captured by the UCP.

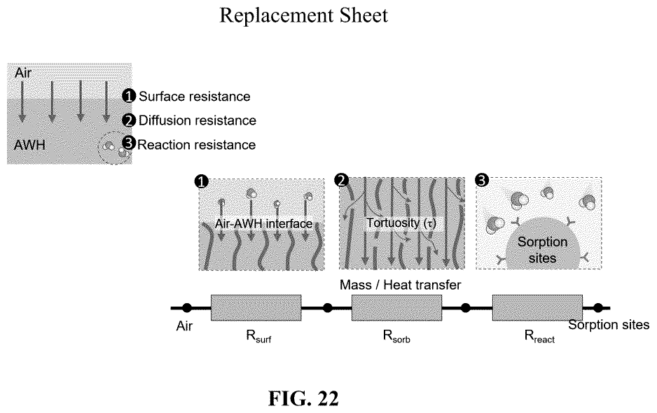

Referring to FIG. 22, there are three steps for moisture capture: i) water molecules transport from the air to the surface of AWH. ii) water molecules diffusion within the AWH through the oriented microchannels and micro pores. iii) the water molecules are captured by the sorption sites of sorbents. During the multi-step sorption process, the heat and mass transport efficiency mainly determined by 3 transport resistance:
(1) Surface Resistance

$${R}_{surf} = \frac{1}{h} \cdot \frac{{A}_{ext}}{A}$$

(2) Diffusion Resistance

$${R}_{sorb} = \frac{τ}{ε} \cdot \frac{{δ}_{sorb}}{{D}_{p}} \cdot \frac{{A}_{ext}}{A}$$

(3) Reaction Resistance

$${R}_{react} = \frac{1}{{K}_{r}} \cdot \frac{{A}_{ext}}{V} .$$

A represents the interface area between nanocomposite and air. Aₑₓₜ is the external surface area of the nanocomposite. h is the surface transport coefficient, which is influenced by the airflow rate. δ_{sorb} is the transport depth. Dₚ is the diffusivity of water vapor in the pore, ε is the porosity, and τ represents the tortuosity. Kᵣ represents the reaction rate coefficient which can be expressed as Kᵣ=1/τᵣ, τᵣ is the characteristic reaction time.

A key aspect of the research on rapid moisture capture is reducing diffusion resistance, which can be controlled by adjusting diffusion depth and tortuosity. The low tortuosity of the prepared AWH minimizes mass transfer resistance, resulting in faster sorption and evaporation kinetics.

The captured heat is directed to a RO desalination unit, which uses thermal energy to drive the desalination process. The RO unit employs a semi-permeable membrane to separate freshwater from saline or brackish water, making it suitable for drinking and other human uses.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “ultra cooling patch” refers to flexible and adhesive thermal management device designed to dissipate heat from photovoltaic panels, reducing their operating temperature and enhancing power generation efficiency.

The term “atmospheric water harvester” refers to a component of the UCP that uses hygroscopic materials and hydrogel structures to capture moisture from ambient air for water production.

The term “thermal regulating layer” refers to a layer within the UCP designed to manage heat transfer, enabling efficient dissipation of thermal energy from photovoltaic panels.

The term “adhesive layer” refers to the bottom layer of the UCP that provides secure, reversible attachment to various substrates without damaging the surface.

The term “hygroscopic materials” refers to substances that readily absorb moisture from the air, often used in combination with hydrogels to enhance water harvesting performance.

The term “passive cooling” means a method of reducing temperature without the use of active energy inputs, often relying on natural processes such as evaporation or radiation.

The term “RO desalination unit” refers to a system that removes salts and impurities from water by forcing it through a semi-permeable membrane using thermal or mechanical energy.

The term “power density” refers to the amount of electrical power generated per unit area of a photovoltaic panel, often expressed in watts per square meter (W/m²). The term “cooling power density” refers to the rate of heat dissipation per unit area of the cooling system.

The term “directional freezing casting” means a manufacturing process that creates aligned porous structures in hydrogels by controlling the direction of ice crystal growth during freezing.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### INDUSTRIAL APPLICABILITY

The UCP offers a sustainable, scalable, and cost-effective solution for enhancing photovoltaic panel performance while addressing global challenges such as energy generation and freshwater scarcity. Its combination of flexible installation, efficient cooling, and moisture extraction makes it a promising technology for both commercial and residential use. Additionally, the UCP demonstrates practical potential for charging commercial smartwatches and can easily scale to larger PV systems.

What is claimed is:

1. A power-water cogeneration system with integrated thermal management and water generation, comprising:
a photovoltaic (PV) panel for converting sunlight into electrical power;
an ultra-cooling patch (UCP) attached to the PV panel, the UCP comprising:
an atmospheric water harvester (AWH) layer with aligned channels, wherein the AWH layer comprises a hydrogel material crosslinked with hygroscopic materials for capturing and storing moisture;
a thermal regulating layer configured to dissipate heat through latent heat evaporation and enhanced thermal conduction; and
an adhesive layer enabling secure and reversible attachment of the UCP to the PV panel; and
a desalination unit for converting saline water into freshwater using the thermal energy captured by the UCP,
wherein the AWH layer captures moisture from air during nighttime, facilitating a radiative cooling effect, while the PV panel enhances moisture absorption efficiency, during daylight hours, excess heat from the PV panel is used to evaporate water within the UCP, and the latent heat of evaporation contributes to cooling the PV panel.

2. The power-water cogeneration system of claim 1, wherein the hydrogel material comprises polyurethane, melamine, cellulose, alginate, polyvinyl alcohol, polyacrylamide, and the hygroscopic materials comprise LiCl, CaCl₂, MgCl₂, ZnCl₂, Mofs, or a combination thereof.

3. The power-water cogeneration system of claim 2, wherein the AWH layer comprises pores interconnected with low tortuosity channels for rapid mass and heat transfer.

4. The power-water cogeneration system of claim 1, wherein the thermal regulating layer is formed from materials with high thermal conductivity selected from graphite, aluminum, or copper.

5. The power-water cogeneration system of claim 1, wherein the adhesive layer comprises silicone-based materials, acrylic acid, Sec-Butyl acetate, or a combination thereof.

6. The power-water cogeneration system of claim 1, wherein the silicone-based materials comprise polydimethylsiloxane, a silicone elastomer, and a silicone adhesive, or a combination thereof.

7. The power-water cogeneration system of claim 1, wherein the PV panel comprises a rigid PV panel and a flexible PV panel.

8. The power-water cogeneration system of claim 1, wherein the UCP is further configured into a fin-like structure with an increased surface area of at least 30% to enhance the cooling rate.

9. The power-water cogeneration system of claim 1, wherein the UCP has a thickness of 1 mm to 15 mm.

10. The power-water cogeneration system of claim 1, wherein the thermal regulating layer maintains a cooling power density of at least 600 W/m² under high solar intensity conditions.

11. The power-water cogeneration system of claim 1, wherein the adhesive layer enables the UCP to undergo at least 50 cycles of attachment and detachment without loss of adhesion.

12. The power-water cogeneration system of claim 1, wherein the UCP reduces the operating temperature of the PV panel by at least 24° C. under typical solar exposure, thereby increasing the power generation efficiency of the PV panel by at least 20%.

13. A method for improving photovoltaic panel performance and generating freshwater, comprising:
attaching an ultra-cooling patch (UCP) to a photovoltaic (PV) panel, wherein the UCP including:
an atmospheric water harvester (AWH) layer with aligned channels, wherein the AWH layer comprises a hydrogel material crosslinked with hygroscopic materials for capturing and storing moisture;
a thermal regulating layer configured to dissipate heat through latent heat evaporation and enhanced thermal conduction; and
an adhesive layer enabling secure and reversible attachment of the UCP to the PV panel; and
harvesting the moisture from ambient air during nighttime via the AWH layer, and dissipating heat during daylight hours via the thermal regulating layer to reduce the temperature of the PV panel;
condensing vapor produced by the UCP to generate freshwater,
wherein the method enhances power generation efficiency by maintaining the PV panel at an optimal operating temperature while simultaneously generating freshwater.

14. The method of claim 13, wherein the hydrogel material is crosslinked using a 30 wt. % calcium chloride solution.

15. The method of claim 13, further comprising reshaping the UCP into a folded configuration to enhance heat transfer efficiency.

16. The method of claim 13, wherein the moisture captured by the AWH is stored in a condensation chamber for subsequent use in irrigation or drinking.

17. The method of claim 13, wherein the UCP maintains its cooling performance over a three-month period under fluctuating environmental conditions.
